(19) United States
(12) Patent Application Publication
(10) Pub. No.: US 2025/0359590 A1
(43) Pub. Date: Nov. 27, 2025

(54) VAPE PEN WITH A HEATING ELEMENT

(71) Applicant: Breeze Smoke, LLC, Warren, MI (US)

(72) Inventor: Mark Faraj, Warren, MI (US)

(73) Assignee: Breeze Smoke, LLC, Warren, MI (US)

(21) Appl. No.: 18/669,807

(22) Filed: May 21, 2024

(51) Int. Cl. A24F 40/46; A24F 40/10; A24F 40/44; A24F 40/485; H05B 3/24

(52) U.S. Cl. CPC A24F 40/46; A24F 40/10; A24F 40/44; A24F 40/485; H05B 3/24; H05B 2203/004; H05B 2203/021

(57) ABSTRACT

A vape pen includes a first housing and a mouthpiece detachably and electrically coupled to the first housing. The mouth piece is configured to accommodate a liquid and a heating element for atomizing the liquid. The heating element includes a first tube includes an inlet for receiving the liquid, the inlet having a main-slit portion, a bottom-slit portion and a top-slit portion spaced apart from the bottom-slit portion, the main-slit portion interconnecting the top-slit portion to the bottom-slit portion. The heating element further includes a pair of electrical leads for conducting electrical power from the power source and a wire mesh disposed between the pair of electrical leads, the wire mesh configured to generate heat when energized so as to atomize the liquid.

### TECHNICAL FIELD

The present specification generally relates to a vape pen having a heating element.

### BACKGROUND

In general, electronic devices that produce an inhalable aerosol (commonly referred to as vape pens) includes a heating element configured to generate sufficient heat to vaporize a liquid. Some of the vape pens are disposable wherein the heating element and the liquid are stored in a handheld device and the vape pen is discarded when the liquid is spent. Some of the vape pens are configured to be reusable, wherein the battery and the liquid may be replaced and or replenished.

The quality of the vape pen depends upon the vaporization/atomization of the liquid. On one end, liquid that is not sufficiently vaporized/atomized may result in the user inhaling liquid droplets which may cause discomfort. However, in instances where the liquid is vaporized/atomized Air too finely, the flavor of the inhalant may be diluted.

The vaporization/atomization of the liquid is based upon many factors to include the amount of heat generated and the amount of liquid applied to the heat. For instance, if the liquid is not evenly distributed along the heating element, the atomization of the liquid may result in vapor particles of different volumes. Likewise, if the heating element does not evenly distribute heat, the atomization of the liquid may result in vapor particles of different volumes.

Conventional vape pens include a steel tube and a heating unit is disposed within the steel tube. The steel tube includes an oval shaped aperture that allows the liquid to flow onto the heating unit. Thus, a concentration of the liquid at the opening may be greater than a concentration of the liquid in areas of the tube displaced from the aperture. Thus, the liquid may not be evenly distributed along the heating unit.

Accordingly, it is desirable to have a vape pen configured to generate an even distribution of heat along the heating unit and generate an even distribution of liquid along the heating unit.

### SUMMARY

In one aspect, a vape pen includes a first housing and a mouthpiece. The first housing is configured to store a power source. The mouthpiece is detachably and electrically coupled to the first housing. The mouthpiece includes a second housing defining a compartment for accommodating a liquid. The mouthpiece includes a heating element for atomizing the liquid. The heating element includes a first tube having at least one inlet for receiving the liquid. The inlet includes a main-slit portion, a bottom-slit portion and a top-slit portion spaced apart from the bottom-slit portion. The main-slit portion interconnects the top-slit portion to the bottom-slit portion. The heating element further includes a pair of electrical leads for conducting electrical power from the power source and a wire mesh disposed between the pair of electrical leads. The wire mesh is configured to generate heat when energized so as to atomize the liquid.

The system may include one or more of the following optional features. In one aspect, of the vape pen the wire mesh has a plurality of hexagon shaped structures arranged in a side-by-side manner so as to form a lattice structure. The hexagon shaped structures may be irregular hexagon shape. In such an aspect, each of the plurality of hexagon shaped structures may include a pair of legs disposed on opposite ends of a corresponding one of the plurality of hexagon shaped structures.

In one configuration, each of the pair of electrical leads may include a bend.

In one configuration, the first tube includes a plurality of inlets. In such an aspect, each one of the plurality of inlets may be equally spaced apart from each other.

In one configuration, the vape pen may further include a wicking unit. The wicking unit bounds a periphery of the wire mesh. In such a configuration, the wicking unit may include a first sheet and a second sheet. The first sheet may be formed of cotton and the second sheet may be formed of a fire retardant material. In addition, the first sheet may be interposed between the wire mesh and the second sheet.

In one configuration, the vape pen may include a second tube. The first tube may be concentric to the second tube. The second tube may include a window through which the liquid is configured to enter and the wire mesh may be disposed within the second tube.

In another aspect of the disclosure, a heating element for use in a vape pen is provided. The vape pen including a first housing storing a power source and a mouthpiece detachably coupled to the first housing, the heating element disposed in the mouthpiece, the heating element comprising: a first tube having at least one inlet for receiving the liquid. In one aspect, the inlet may include a main-slit portion, a bottom-slit portion and a top-slit portion spaced apart from the bottom-slit portion, the main-slit portion interconnecting the top-slit portion to the bottom-slit portion. The heating element may further include a pair of electrical leads for conducting electrical power from the power source and a wire mesh disposed between the pair of electrical leads, the wire mesh configured to generate heat when energized so as to atomize the liquid.

In one configuration, the first tube includes a plurality of inlets. In such a configuration, each one of the plurality of inlets may be equally spaced apart from each other. Further, a width of the top-slit portion, the bottom-slit portion and the main-slit portion is the same. Further, in another aspect, the main-slit portion may bisect the top-slit portion and the bottom-slit portion.

In another aspect of the disclosure, a wire mesh for generating heat in a vape pen is provided. The vape pen includes a first housing storing a power source and a mouthpiece detachably coupled to the first housing. The mouthpiece includes a heating element and the wire mesh is disposed within the heating element, the wire mesh comprising: a pair of electrical leads for conducting electrical power; a plurality of elongated members connected to each other to form a plurality of hexagon shaped structures arranged in a side-by-side manner, the plurality of hexagon shaped structures disposed between the pair of electrical leads. In one aspect, the hexagon shaped structures are irregular hexagon shape. In another aspect, each of the pair of electrical leads includes a bend.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 is an exemplary depiction of a vape pen according to one or more embodiments illustrated herein.

FIG. 2 is an exploded view of the vape pen shown in FIG. 1.

FIG. 3 is an exploded view of the first housing of the vape pen shown in FIG. 2.

FIG. 4 is cross-sectional view of the first housing shown in FIG. 2, taken along line 4-4.

FIG. 5 is an exploded view of the mouthpiece shown in FIG. 2.

FIG. 6 is a cross-sectional view of the mouthpiece shown in FIG. 2, taken along line 6-6.

FIG. 7 is an exploded view of the heating element shown in FIG. 5.

FIG. 8 is an isolated view of the wire mesh.

FIG. 9 is a cross-sectional view of the heating element shown in FIG. 5, taken along line 9-9.

### DETAILED DESCRIPTION OF PREFERRED EMBODIMENTS

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Referring generally to the figures, embodiments of the present disclosure include a vape pen having a first housing and a mouthpiece. The first housing is configured to store a power source. The mouthpiece is detachably and electrically coupled to the first housing. The mouthpiece is configured to store a liquid to be atomized. In particular, the mouthpiece includes a heating element for atomizing the liquid wherein the heating element is configured to generate heat evenly and distribute the liquid evenly over the heating element. As used herein, the term “atomize” may be construed synonymously with “vaporize”.

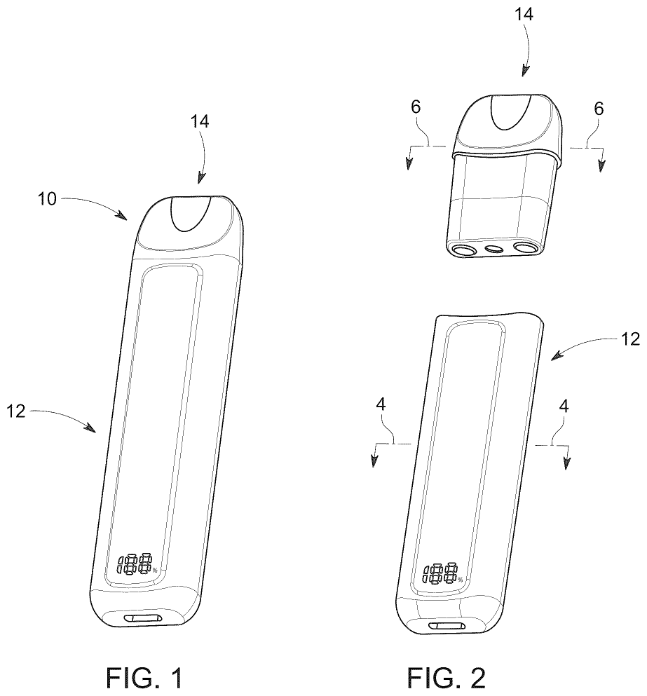

With reference first to FIGS. 1 and 2, a vape pen 10 in accordance with one or more aspects described herein is provided. The vape pen 10 includes a first housing 12 and a mouthpiece 14 that is detachably coupled to the first housing 12. The first housing 12 is configured to be held by a user and includes a compartment 16 for storing a power source 18 such as a disposable battery or a rechargeable battery.

In instances where the power source 18 is disposable battery, the first housing 12 may include a removable panel (not shown) for providing access to the disposable battery to allow for the disposable battery to be replaced. In instances where the power source 18 is a rechargeable battery, the first housing 12 may include a power input 20 for receiving a cable, such as a USB-C cable. The first housing 12 may be formed of a durable and resilient material that is suitable for an injection molding process. A top portion of the first housing 12 may include a first opening 22 for receiving the mouthpiece 14, wherein a bottom portion of the mouthpiece 14 is seated within the first opening 22.

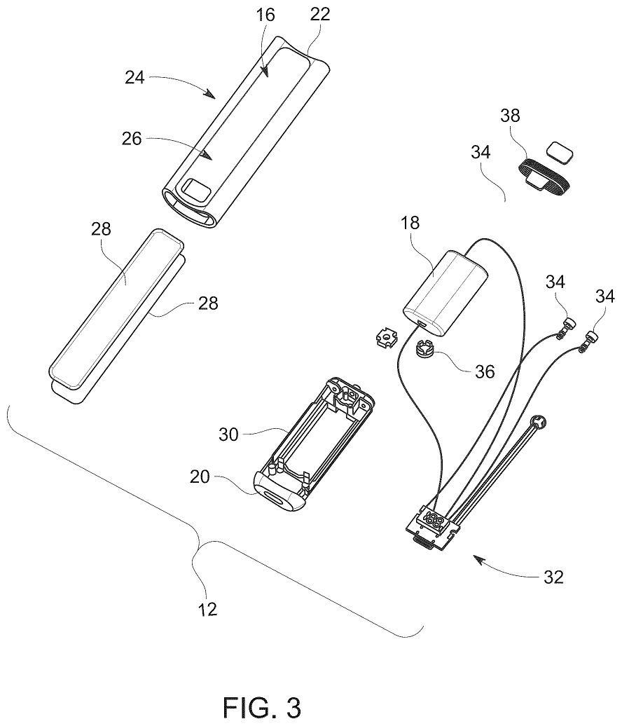

With reference now to FIG. 3, an exploded view of the first housing 12 is provided. In one aspect, the first housing 12 includes a frame 24 having a pair of panel openings 26 and a pair of panels 28 which are fitted into the panel openings 26 to define a back wall and front wall of the first housing 12. A holder 30 is disposed within the frame 24 and is configured to secure the power source 18 within the first housing 12.

A control unit 32 is disposed within the first housing 12 and is electrically coupled to the power source 18. The control unit 32 includes electrical components and processors configured to provide operational functions and measurements of the vape pen 10. For instance, the control unit 32 may be configured to turn on and off the vape pen 10, and the electrical components may be configured to measure the amount of power left in the power source 18, count the number of draws performed by a user and detect air flow. For instance, one of the electrical components may be an air-flow sensor 36.

A pair of electrodes 34 are coupled to a positive and negative terminal of the power source 18 so as to provide an electrical path when connected. It should be appreciated that the pair of electrodes 34 need not be directly coupled to the power source 18. For instance, in one aspect, the electrodes 34 are connected to the control unit 32 via a pair of wires and the control unit 32 is directly connected to the power source 18 via a pair of wires (not shown). In one aspect, the electrodes 34 may be a magnetic suction electrode having a ring magnet portion and an electrode portion that is seated within the ring magnet portion. A first gasket 38 is interposed between the top of the frame 24 and the holder 30 so as to help prevent water and the liquid inhalant from being introduced into the frame 24.

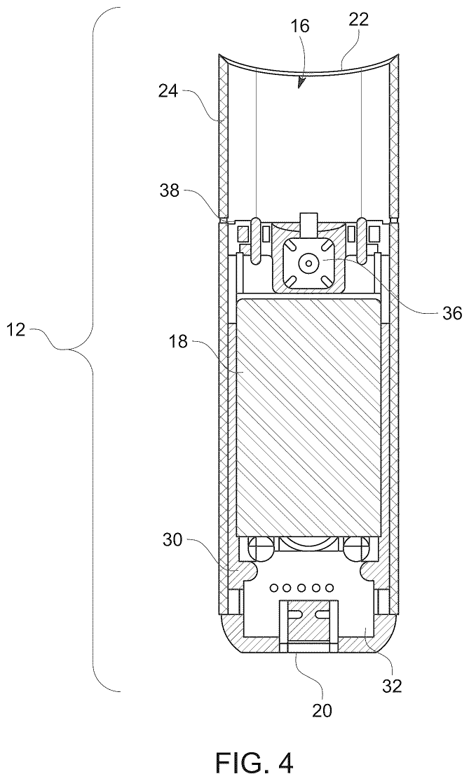

FIG. 4 illustrates how the components of the first housing 12 are packaged. The control unit 32 is disposed at a bottom end of the frame 24 and is configured to receive a terminal of a charging cable (not shown). As the power source 18 is being charged, the control unit 32 may monitor the state of charge of the power source 18 to provide the user with various charging information such as the time left to charge and/or the percentage of charge of the power source 18, e.g. the state of charge. In one aspect, the percentage of charge may be displayed on the first housing 12.

The control unit 32 may be further configured to determine the number of times the heating element 58 is actuated. This may be done by detecting the number of times power is discharged from the power source 18. By counting the number of times the heating element 58 has been turned on, the control unit 32 may calculate how many puffs (e.g. how many inhalations or draws) are left. For instance, knowing the amount of liquid inhalant stored within a mouthpiece 14, and knowing the duration that the heating element 58 is actuated, the control unit 32 may calculate a burn rate of the liquid inhalant, how much liquid inhalant is left and a number of puffs remaining based upon an average burn rate and how much liquid inhalant remains. Other parameters such as the length of time the heating element 58 is actuated may also be processed to determine the number of puffs are left. For instance, if the initial volume of the liquid in the stored in the mouthpiece 14 is known, and an assumed consumption of the liquid by the heating element 58 is known, the control unit 32 may process such information to provide the number of puffs remaining.

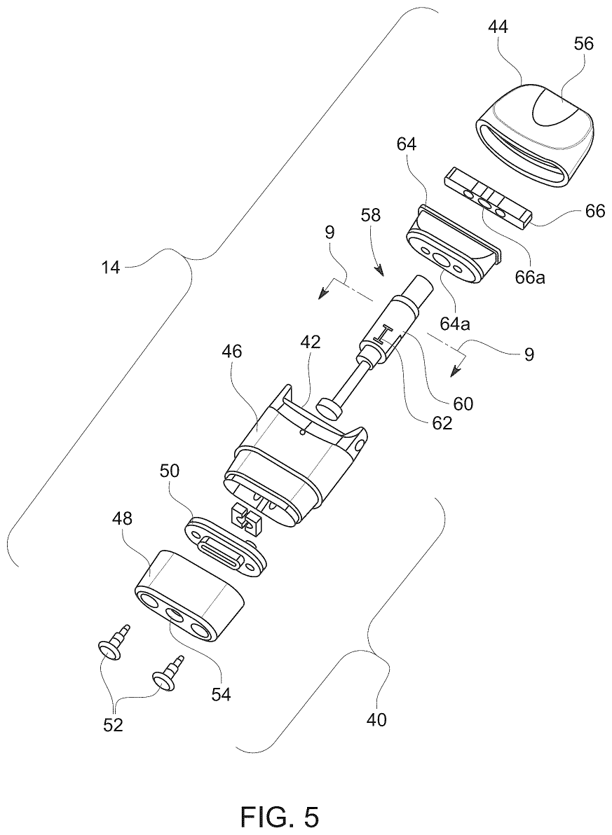

With reference again to FIG. 2 and now to FIG. 5, the mouthpiece 14 is configured to atomize the liquid inhalant so as to generate an inhalant and provide an outlet for drawing the inhalant. The mouthpiece 14 includes a second housing 40 defining a storage 42 for accommodating the liquid inhalant and a cover 44 for closing the second housing 40. The second housing 40 may include a main body 46 and a cup portion 48 configured to accommodate the main body 46. A second gasket 50 may be disposed between the main body 46 and the cup portion 48 so to prevent the liquid inhalant from leaking. Alternatively, the second housing 40 may be formed as a unitary structure.

The cover 44 is illustratively shown as being a tapered structure to accommodate the pressing of a user's lips so as to generate a seal. The second housing 40 is dimension to be seated within the first opening 22 of the first housing 12. A bottom of the second housing 40 may include electrical contacts 52 for creating an electrical connection with the power source 18. It should be appreciated that the vape pen 10 may include common electrical components for regulating and routing power from the power source 18 to the mouthpiece 14. The second housing 40 may further include an air inlet 54 disposed on the bottom surface of the cup portion 48 for drawing air into the mouthpiece 14 and an air outlet 56 may for formed on a top surface of the cover 44 for drawing the atomized inhalant.

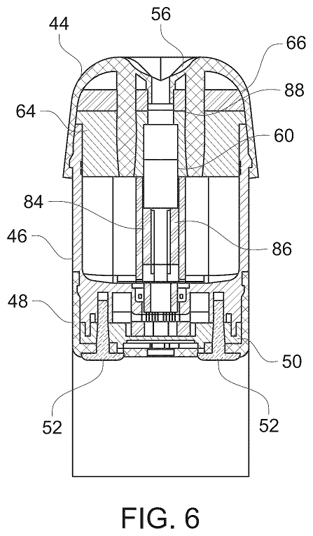

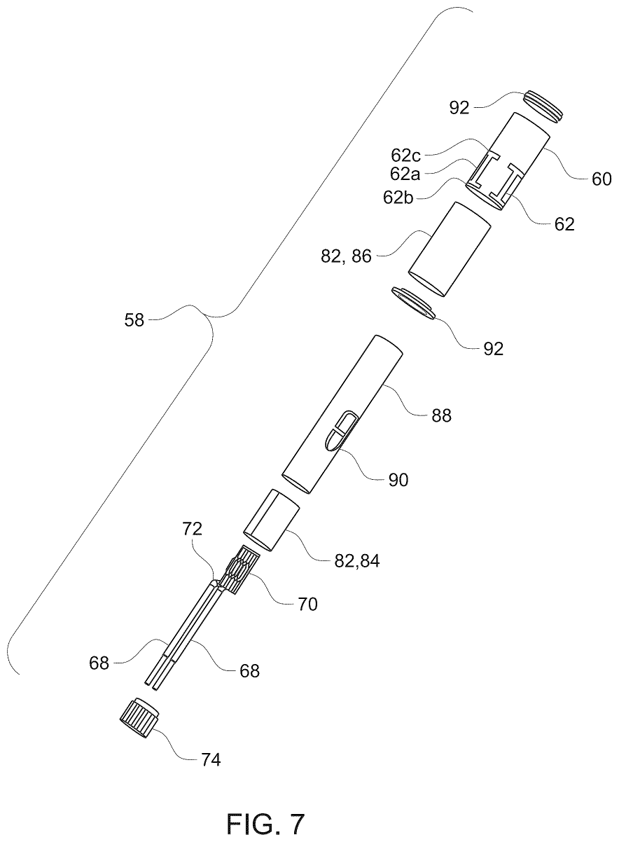

With reference again to FIG. 5 and now to FIGS. 6 and 7, the mouthpiece 14 includes a heating element 58 for atomizing the liquid. The heating element 58 is disposed within the second housing 40 and is closed by the cover 44. The heating element 58 is configured to atomize the liquid inhalant and is powered by the power source 18. The heating element 58 includes a first tube 60 having at least one inlet 62 for receiving the liquid inhalant. The first tube 60 is formed of a material configured to withstand a temperature sufficient to vaporize the liquid inhalant, such as stainless steel. The inlet 62 may be configured to have a cross-section similar to that of an I-beam. As shown includes a main-slit portion 62a, a bottom-slit portion 62b and a top-slit portion 62c spaced apart from the bottom-slit portion 62b. The main-slit portion 62a interconnects the top-slit portion 62c to the bottom-slit portion 62b. In one aspect, the first tube 60 includes a plurality of inlets 62. In such an aspect, each one of the plurality of inlets 62 may be equally spaced apart from each other.

The mouthpiece 14 may further include a support member 64 disposed within the main body 46 and configured to fix the heating element 58 within the main body 46. The support member 64 includes an aperture 64a configured to receive a top portion of the heating element 58. The support member 64 may be formed of a resilient material such as a natural or synthetic rubber. A third gasket 66 is seated on top of the support member 64. The third gasket 66 includes an aperture 66a that is in fluid communication with the aperture 64a of the support member 64 so as to provide a passage for the vaporized liquid through the air outlet 56.

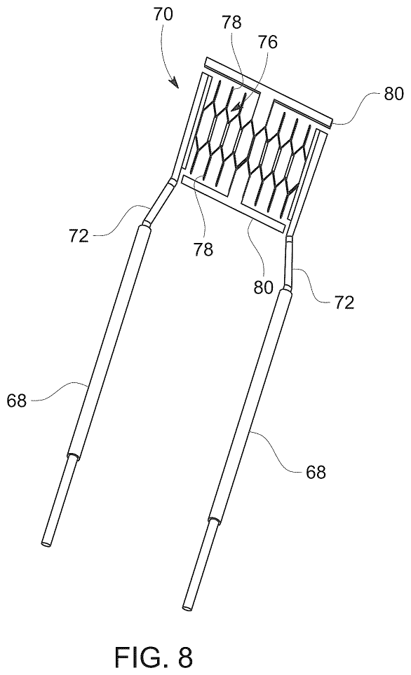

With reference again to FIG. 5 and now to FIGS. 7 and 8, the heating element 58 further includes a pair of electrical leads 68 for conducting electrical power from the power source 18 and a wire mesh 70 disposed between the pair of electrical leads 68. Each of the pair of electrical leads 68 may include a bend 72. The bend 72 angles inwardly toward each other. The electrical leads 68 may be covered by an electrically insulating material. A fixation member 74 may be provided to keep the electrical leads 68 spaced apart from each other in a fixed position. The fixation member 74 is a cylindrical unit having a plurality of teeth that are spaced apart from each other to accommodate a corresponding one of the pair of electrical leads 68. The fixation member 74 is fitted within second tube 88 of the mouthpiece 14 and the electrical leads 68 are fitted to the teeth of the fixation member 74, keeping the electrical leads spaced apart from each other in a fixed position.

The wire mesh 70 is configured to generate heat when energized so as to atomize the liquid. The wire mesh 70 has a plurality of hexagon shaped structures 76 arranged in a side-by-side manner so as to form a lattice structure. The hexagon shaped structures 76 may be irregular hexagon shape. Each of the plurality of hexagon shaped structures 76 may include a pair of legs 78 disposed on opposite ends of a corresponding one of the plurality of hexagon shaped structures 76. The wire mesh 70 further includes a pair of stabilizing bars 80 disposed on a top and bottom edge of the wire mesh 70.

With reference again to FIG. 7, heating element 58 may further include a wicking unit 82. The wicking unit 82 bounds a periphery of the wire mesh 70. In such a configuration, the wicking unit 82 may include a first sheet 84 and a second sheet 86. The first sheet 84 may be formed of cotton and the second sheet 86 may be formed of a fire retardant material. In addition, the first sheet 84 may be interposed between the wire mesh 70 and the second sheet 86.

The heating element 58 may include a second tube 88. The first tube 60 may be concentric to the second tube 88 so as to place the second tube 88 within the first tube 86. The second tube 88 is longer than the first tube 60. The second tube 88 may include a window 90 through which the liquid inhalant is configured to enter and the wire mesh 70 may be disposed within the second tube 88. In one aspect, the second tube 88 includes a pair of windows 90 disposed opposite of each other. The heating element 58 may further include a pair of spacers 92. The spacers 92 may be formed of a rigid material configured to withstand the heat generated by the wire mesh 70, such as copper. The spacers 92 are in the shape of a ring and one of the spacers 92 is fitted beneath the first tube 60 and supports the wicking unit 82 so as to prevent the wicking unit 82 from sliding out of the first tube 60. The wicking unit 82 is concentric to the second tube 88 so as to be supported by the second tube 88. The other spacer 92 is seated on top of the first tube 60 and retains the wicking unit 82 within the first tube 60.

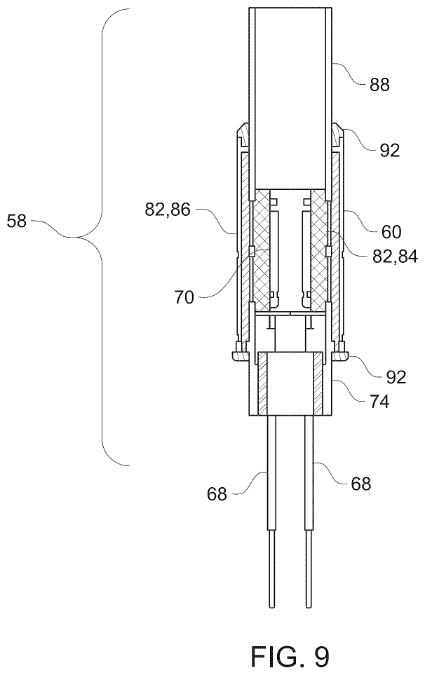

With reference now to FIG. 9, the wire mesh 70 is formed in a roll, wherein the electrical leads 68 are brought together and spaced apart from each other by the fixing member 74. The second sheet 86 is wrapped around the wire mesh 70. The wire mesh 70 and the second sheet 86 are held within the second tube 88. The first sheet 84 is wrapped around the second tube 88 so as to be concentric with the wire mesh 70 and the second sheet 86 so as to form a sub-assembly which is disposed within the first tube 60. The stabilizing bars 80 and the wire mesh 70 help the second sheet 86 retain its form during the vaporization process. In particular, as the wire mesh 70 generates heat, the second sheet 86 may shrink or be drawn into itself. However, the stabilizing bars 80 and the wire mesh 70 help the second sheet 86 retain its shape. Likewise, the heat generated by the wire mesh 70 may cause the first sheet 84 to shrink or be drawn into itself. However, as the second sheet 86 is held between the first tube 60 and the second tube 80, the first sheet 84 retains its shape during the heating process.

In another aspect of the disclosure, a heating element 58 for use in a vape pen 10 is provided. The vape pen 10 includes a first housing 12 storing a power source 18 and a mouthpiece 14 detachably coupled to the first housing 12. The heating element 58 is disposed in the mouthpiece 14 and includes a first tube 60 having at least one inlet 62 for receiving the liquid inhalant. The inlet 62 includes a main-slit portion 62a, a bottom-slit portion 62b and a top-slit portion 62c spaced apart from the bottom-slit portion 62b. The main-slit portion 62a interconnects the top-slit portion 62c to the bottom-slit portion 62b so as to provide a seamless I-shaped opening. The heating element 58 further includes a pair of electrical leads 68 for conducting electrical power from the power source 18 and a wire mesh 70 disposed between the pair of electrical leads 68. The wire mesh 70 configured to generate heat when energized so as to atomize the liquid inhalant.

In one configuration, the first tube 60 includes a plurality of inlets 62. In such a configuration, each one of the inlets 62 may be equally spaced apart from each other. Further, a width of the top-slit portion 62c, the bottom-slit portion 62b and the main-slit portion 62a is the same. In another aspect, the main-slit portion 62a bisects the top-slit portion 62c and the bottom-slit portion 62b.

In another aspect of the disclosure, a wire mesh 70 for generating heat in a vape pen 10 is provided. The vape pen 10 includes a first housing 12 storing a power source 18 and a mouthpiece 14 detachably coupled to the first housing 12. The mouthpiece 14 includes a heating element 58 and the wire mesh 70 is disposed within the heating element 58. The wire mesh 70 includes a pair of electrical leads 68 for conducting electrical power and a plurality of elongated members connected to each other to form a plurality of hexagon shaped structures 76 arranged in a side-by-side manner. The hexagon shaped structures 76 are disposed between the pair of electrical leads 68. In one aspect, the hexagon shaped structures 76 are irregular hexagon shape. In another aspect, each of the pair of electrical leads 68 includes a bend 72.

In operation, the mouthpiece 14 is inserted into the first housing 12. In one aspect, the mouthpiece 14 is configured to be disposable. In another aspect, the mouthpiece 14 is refillable, wherein the mouthpiece 14 may include an intake (not shown) for introducing a liquid inhalant. In such an aspect, the intake may be sealed by a cap or a resilient self-closing valve. The first housing 12 may include an input (not shown), such as a button, for turning on the power in which case, as the user takes a draw from the mouthpiece 14, the liquid inhalant is vaporized and the vapors are inhaled by the user. The control unit 32 may calculate the number of puffs taken and process the number of puffs to determine how many puffs are left. In addition, the control unit 32 may be in communication with an electric component such as a sensor that is configured to detect the amount of power left in the power source 18 such as a battery.

The heating element 58 is powered during each draw, wherein the wire mesh 70 is heated to a sufficient temperature to vaporize the liquid inhalant. The first tube 60 and the second tube 88 are spaced apart from each other with the second sheet 86 interposed between the first tube 60 and the second tube 88 which provides a consistent path for the introduction of the liquid inhalant into the wire mesh 70. Further, the stabilizing bars 80 prevent the second sheet 86 from shrinking and closing in on itself as a result of the heat generated by the wire mesh 70 so as to retain a consistent path for airflow.

Accordingly, the vape pen 10 described herein includes a heating element 58 that provides a consistent airflow for vaping.

While particular embodiments have been illustrated and described herein, it should be appreciated and understood that various other changes and modifications may be made without departing from the spirit and scope of the claim subject matter. Moreover, although various aspects of the claim subject matter have been described herein, such aspects need not be utilized in combination. It is therefore intended that the appended claims cover all such changes and modifications that are within the scope of the claim subject matter.

1. A vape pen comprising:
a first housing configured to store a power source;
a mouthpiece detachably and electrically coupled to the first housing, the mouth piece including a second housing defining a compartment for accommodating a liquid; and
a heating element for atomizing the liquid, the heating element including a first tube having at least one inlet for receiving the liquid, the at least one inlet having a main-slit portion, a bottom-slit portion and a top-slit portion spaced apart from the bottom-slit portion, the main-slit portion interconnecting the top-slit portion to the bottom-slit portion; and
wherein the heating element further includes a pair of electrical leads for conducting electrical power from the power source and a wire mesh disposed between the pair of electrical leads, the wire mesh configured to generate heat when energized so as to atomize the liquid.

2. The vape pen as set forth in claim 1, wherein the wire mesh has a plurality of hexagon shaped structures arranged in a side-by-side manner so as to form a lattice structure.

3. The vape pen as set forth in claim 2, wherein the hexagon shaped structures are irregular hexagon shape.

4. The vape pen as set forth in claim 2, wherein each of the plurality of hexagon shaped structures includes a pair of legs disposed on opposite ends of a corresponding one of the plurality of hexagon shaped structures.

5. The vape pen as set forth in claim 1, wherein each of the pair of electrical leads includes a bend.

6. The vape pen as set forth in claim 1, wherein at least one inlet is a plurality of inlets.

7. The vape pen as set forth in claim 6, wherein each one of the plurality of inlets is equally spaced apart from each other.

8. The vape pen as set forth in claim 1, further including a wicking unit, the wicking unit bounding a periphery of the wire mesh.

9. The vape pen as set forth in claim 1, wherein the wicking unit includes a first sheet and a second sheet, the first sheet is formed of cotton and the second sheet is formed of a fire retardant material.

10. The vape pen as set forth in claim 9, wherein the first sheet is interposed between the wire mesh and the second sheet.

11. The vape pen as set forth in claim 1, further including a second tube, the first tube concentric to the second tube, the second tube including a window through which the liquid is configured to enter, the wire mesh disposed within the second tube.

12. A heating element for use in a vape pen, the vape pen including a first housing storing a power source and a mouthpiece detachably coupled to the first housing, the heating element disposed in the mouthpiece, the heating element comprising:
a first tube having at least one inlet for receiving the liquid, the at least one inlet having a main-slit portion, a bottom-slit portion and a top-slit portion spaced apart from the bottom-slit portion, the main-slit portion interconnecting the top-slit portion to the bottom-slit portion; and
a pair of electrical leads for conducting electrical power from the power source and a wire mesh disposed between the pair of electrical leads, the wire mesh configured to generate heat when energized so as to atomize the liquid.

13. The heating element as set forth in claim 12, wherein at least one inlet is a plurality of inlets.

14. The heating element as set forth in claim 13, wherein each one of the plurality of inlets is equally spaced apart from each other.

15. The heating element as set forth in claim 13, a width of the top-slit portion, the bottom-slit portion and the main-slit portion is the same.

16. The heating element as set forth in claim 13, wherein the main-slit portion bisects the top-slit portion and the bottom-slit portion.

17. A wire mesh for generating heat in a vape pen, the vape pen including a first housing storing a power source and a mouthpiece detachably coupled to the first housing, the mouthpiece including a he heating element and the wire mesh is disposed within the heating element, the wire mesh comprising:
a pair of electrical leads for conducting electrical power;
a plurality of elongated members connected to each other to form a plurality of hexagon shaped structures arranged in a side-by-side manner, the plurality of hexagon shaped structures disposed between the pair of electrical leads.

18. The wire mesh as set forth in claim 17, wherein the hexagon shaped structures are irregular hexagon shape.

19. The wire mesh as set forth in claim 17, wherein each of the pair of electrical leads includes a bend.
